(19) United States
(12) Patent Application Publication
(10) Pub. No.: US 2026/0233681 A1
(43) Pub. Date: Aug. 13, 2026

(54) FLOOR CONSOLE OF VEHICLE

(71) Applicants: Hyundai Motor Company, Seoul (KR); Kia Corporation, Seoul (KR); KAIEM Inc., Busan (KR)

(72) Inventors: Min Woo KWON, Hwaseong-si (KR); Hyun Woo KWON, Hwaseong-si (KR); Hyeon Seok LEE, Hwaseong-si (KR); Tae Yoon KIM, Hwaseong-si (KR); Kang Min LEE, Hwaseong-si (KR); Sung Hwan KIM, Hwaseong-si (KR); Hong Sik CHANG, Hwaseong-si (KR); Sang Jin JOUNG, Ulsan (KR); Nam Su PARK, Suwon-si (KR); Jae Yeon JEONG, Suwon-si (KR); Kyoung Sik KIM, Ansan-si (KR)

(21) Appl. No.: 19/229,306

(22) Filed: Jun. 5, 2025

(30) Foreign Application Priority Data
Feb. 13, 2025 (KR) 10-2025-0018929

(51) Int. Cl. B60R 7/04; B60N 3/00

(52) U.S. Cl. CPC B60R 7/04; B60N 3/001

(57) ABSTRACT

A floor console of a vehicle includes a base including a portion of a storage box or armrest of the vehicle, and a multifunctional panel hingedly that is coupled to the base, that is rotatable in a first direction or a second direction relative to the base, and that includes a securing module at one side thereof. A portion of the securing module is configured to, based on the multifunctional panel rotating in the first direction or the second direction relative to the base, insert into an end of the base and couple to the base.

### CROSS REFERENCE TO RELATED APPLICATION

The present application claims priority of Korean Patent Application No. 10-2025-0018929, filed on Feb. 13, 2025, the entire contents of which are incorporated herein for all purposes by this reference.

### TECHNICAL FIELD

The present disclosure relates to a floor console of a vehicle.

### BACKGROUND

A floor console of a vehicle may be mounted on a vehicle floor between a driver's seat and a passenger's seat and define a storage space for storing items or devices such as a gear shift lever configured to control the vehicle and a knob. A storage box may define a storage space configured to store items such as a smartphone, a wallet, and a key, for instance. In some cases, a top portion of the storage box may cover the storage space and function as an armrest. In some cases, vehicle consoles may include a port for supplying power.

### SUMMARY

A multifunctional panel covers a storage space of a storage box and functions as an armrest while covering the storage space. One point of the multifunctional panel can be rotatably coupled around one point of the storage box. In addition to covering the storage space or functioning as an armrest, the multifunctional panel can perform other functions.

For example, a display can be provided on one surface of the multifunctional panel, or a separate space such as a cup holder can be further provided thereon. In some examples, for safety and other considerations, the vehicle can include a structure capable of securing the multifunctional panel in a rotated state.

The present disclosure describes a floor console of a vehicle, which can secure the multifunctional panel in a rotated state.

Technical objectives of the present disclosure are not limited to the technical objectives mentioned above, and other technical objectives not mentioned above will be clearly understood by those skilled in the art to which the present disclosure pertains from the following description.

According to one aspect of the subject matter described in this application, a floor console of a vehicle includes a base comprising (i) a portion of a storage box of the vehicle or (ii) a portion of an armrest of the vehicle, and a multifunctional panel hingedly coupled to the base and configured to rotate in a first direction and a second direction relative to the base, the multifunctional panel including a securing module disposed at one side thereof. The securing module includes at least one coupling portion that is configured to, based on the multifunctional panel rotating in the first direction or the second direction relative to the base, insert into an end of the base and couple to the base.

Implementations according to this aspect can include one or more of the following features. For example, the base can define a first securing groove at a first end of the base, the first securing groove being configured to, based on the multifunctional panel rotating in the first direction relative to the base, receive the at least one coupling portion of the multifunctional panel and secure the multifunctional panel, and a second securing groove at a second end of the base, the second securing groove being configured to, based on the multifunctional panel rotating in the second direction relative to the base, receive the at least one coupling portion of the multifunctional panel and secure the multifunctional panel.

In some examples, the at least one coupling portion of the securing module can include a first securing part configured to insert into the first securing groove of the base, or a second securing part configured to insert into the second securing groove of the base.

In some implementations, the multifunctional panel can include (i) a first surface configured to define a surface of the armrest of the vehicle based on the multifunctional panel rotating in the first direction relative to the base and coupling to the base, and (ii) a second surface configured to define a table of the vehicle based on the multifunctional panel rotating in the second direction relative to the base and coupling to the base.

In some implementations, the base can define a base storage space that is inwardly recessed from an upper surface of the base, where the multifunctional panel is configured to, based on rotating in the first direction relative to the base, cover the base storage space. In some implementations, the multifunctional panel can define a panel storage space that is recessed from an inner surface of the multifunctional panel, where the multifunctional panel is configured to, based on rotating in the second direction relative to the base, expose the inner surface of the multifunctional panel and the panel storage space.

In some implementations, the securing module can be disposed at an inner side of the multifunctional panel, where the at least one coupling portion of the securing module includes a first securing part and a second securing part, and the securing module is configured to release coupling of the multifunctional panel and the base based on the first securing part or the second securing part moving relative to the base.

In some implementations, the floor console further includes a striker disposed at one side of the base and configured to move the multifunctional panel, and a kick member disposed at a side of the striker and configured to provide a rotational force to the multifunctional panel in the second direction, where the kick member is configured to (i) be pressurized based on the multifunctional panel rotating in the first direction relative to the base and coupling to the base, and (ii) apply an elastic force to the striker to thereby provide the rotational force to the multifunctional panel in the second direction based on the multifunctional panel being released from the base.

In some examples, the first securing part can include a first button accommodated in the multifunctional panel and configured to receive an external force, the first button having an end that is exposed to an outside of the multifunctional panel, a first securing hook connected to the first button and configured to move relative to the first button based on the external force being applied to the first button, and a first connecting link that connects the first button to the first securing hook and configured to move the first securing hook based on the external force being applied to the first button.

In some examples, the first button includes a button housing including a first lower housing and a first upper housing that define an exterior shape of the first button, and a first securing hook sliding shaft connected to a portion between the button housing and the first securing hook and configured to move up and down in the button housing, the first securing hook sliding shaft being configured to move the first securing hook based on the external force being applied to the button housing. The first securing hook sliding shaft can be configured to support an end of the first connecting link and to move the first securing hook while being pressured by the external force applied to the button housing.

In some examples, the first securing hook can include a slope that is disposed at a side of the first securing hook and supports ends of the first securing hook sliding shaft, where the first securing hook sliding shaft is configured to move along the slope and to move the first securing hook based on the external force being applied to the button housing.

In some examples, the first button can include a first securing hook sliding shaft that supports a first end of the first connecting link, where an end of the base supports a second end of the first connecting link, and a portion of the first connecting link between the first end and the second end of the first connecting link is hingedly coupled to an inner side of the securing module.

In some examples, the first button can include a button housing including a first lower housing and a first upper housing that define an exterior shape of the first button, and an elastic member disposed between the first lower housing and the first upper housing and configured to pressurize the first upper housing upward, where the first upper housing is configured to protrude to an outside of the multifunctional panel based on the multifunctional panel rotating in the first direction relative to the base and being released from the base.

In some implementations, the base can define a first securing groove configured to couple to the multifunctional panel, where the first securing hook can include a first end configured to insert into the first securing groove of the base, and the floor console can further include a pressurizing member disposed at a second end of the first securing hook and configured to pressurize the first securing hook toward an outside of the securing module.

In some examples, the first securing hook can include a gear rack that protrudes from one side of the first securing hook, where the securing module can include a gear damper configured to engage with the gear rack of the first securing hook and to restrain the first securing hook from moving relative to the first button. The gear damper can be rotatably provided at an end of the securing module and configured to be rotated by movement of the first securing hook.

In some examples, the second securing part can include a second button accommodated in the multifunctional panel and configured to receive an external force, the second button having an end exposed to an outside of the multifunctional panel, a second securing hook connected to the second button and configured to move relative to the second button based on the external force being applied to the second button, and a second connecting link that connects the second button to the second securing hook and configured to move the second securing hook relative to the second button based on the external force being applied to the second button.

In some implementations, the floor console can include a first button including a button housing, the button housing including a first lower housing and a first upper housing that define an exterior shape of the first button, where the first upper housing defines a hook groove at one side thereof, an elastic member disposed between the first lower housing and the first upper housing and configured to pressurize the first upper housing upward, where the first upper housing is configured to, based on the multifunctional panel rotating in the first direction relative to the base and being released from the base, protrude to an outside of the multifunctional panel, a second button accommodated in the multifunctional panel and configured to receive an external force, the second button having an end exposed to the outside of the multifunctional panel, a second securing hook connected to the second button and configured to move relative to the second button based on the external force being applied to the second button, and a second connecting link that connects the second button to the second securing hook and configured to move the second securing hook relative to the second button based on the external force being applied to the second button. The second securing hook can be disposed at an inner side of the first upper housing and configured to, based on the first upper housing protruding to the outside of the multifunctional panel, protrude to an outside of the first upper housing through the hook groove.

In some examples, the base can define a second securing groove configured to receive the second securing hook and couple to the multifunctional panel in the second direction.

In some implementations, the first securing part can include a first upper housing, and the second connecting link can include a second securing hook sliding link disposed at an inner side of the first upper housing, the second securing hook sliding link having (i) a first end connected to the second securing hook and (ii) a second end hingedly coupled to an inner side of the first upper housing, and a disengaging link having (ii) a first end supported on the second button and (ii) a second end supported on the second end of the second securing hook sliding link.

In some examples, the base can define a second securing groove configured to receive the second securing hook and couple to the multifunctional panel, where the floor console can further include a torsion spring that hingedly couples the second securing hook sliding link to the first upper housing, the torsion spring being configured to pressurize the second securing hook toward the second securing groove. The second securing hook can be configured to, based on the external force being applied to the second button, be released from the second securing groove and allow the multifunctional panel to rotate in the second direction.

In some implementations, the multifunctional panel can be secured in both directions, thereby enabling stable use of the multifunction panel even when the vehicle is driving.

The effects which can be achieved from the present disclosure are not limited to the effects mentioned above, and other effects not mentioned above will be clearly understood by those skilled in the art to which the present disclosure pertains from the following description.

### BRIEF DESCRIPTION OF THE DRAWINGS

FIG. 1 is a view illustrating a portion of an example of a floor console of a vehicle.

FIGS. 2 and 3 are views illustrating example states of the floor console in FIG. 1.

FIG. 4 is an exploded view illustrating an example of a multifunctional panel and a securing module provided therein.

FIG. 5 is an exploded view illustrating an example of first and second securing parts of the securing module.

FIG. 6 is a view illustrating an example of a base for securing of the multifunctional panel rotated in a first direction.

FIG. 7 is a view illustrating an example state in which a first securing hook of the securing module is inserted into a first securing groove for securing of the multifunctional panel rotated in the first direction.

FIG. 8 is a cross-sectional view taken along line B-B in FIG. 7.

FIG. 9 is a cross-sectional view taken along line A-A in FIG. 7.

FIG. 10 is a view illustrating an example of a striker.

FIG. 11 is a cross-sectional view taken along line C-C in FIG. 2.

FIG. 12 is a view illustrating a portion of the securing module with the multifunction panel rotated in the first direction.

FIG. 13 is a view illustrating a portion of the securing module after securing of the multifunctional panel in the first direction is released.

FIG. 14 is a cross-sectional view taken along line D-D in FIG. 13.

FIG. 15 is a cross-sectional view taken along line E-E in FIG. 3.

FIG. 16 is a view illustrating an example state in which the multifunction panel is released from the base.

### DETAILED DESCRIPTION

In describing implementations disclosed herein, when a detailed description of a known related art is determined to obscure the gist of the implementations disclosed herein, the detailed description thereof will be omitted herein. In addition, the accompanying drawings are merely for easy understanding of the implementations disclosed herein, and the technical spirit disclosed herein is not limited by the accompanying drawings, and it should be understood to include all modifications, equivalents, and substitutes included in the spirit and technical scope of the present disclosure. The following disclosure is not intended to limit the present disclosure to the described form or a certain field. It should be considered that various alternative aspects and variations of the present disclosure are possible, whether explicitly stated or implied herein. Those skilled in the art to which the present disclosure pertains will recognize that the form and details of the subject matter disclosed herein can be modified.

In addition, a unit or control unit included in names is merely a term widely used in the naming of a controller that controls the certain function of a vehicle, but may not mean a generic function unit.

A controller can include a communication device for communicating with other control units or sensors to control a responsible function, a memory for storing an operating system, a logic command, and input/output information, and at least one processor for executing determination, calculation, and decision which are for controlling the responsible function.

Hereinafter, implementations disclosed herein will be described in detail with reference to the drawings. The same reference numerals are given to the same or similar components regardless of reference numerals, and a repetitive description thereof will be omitted.

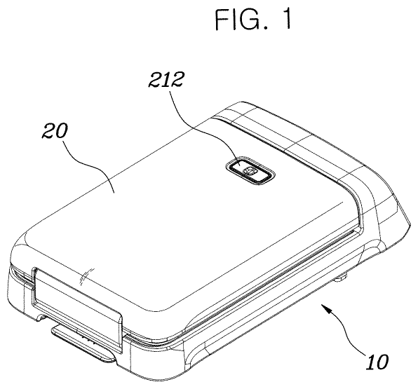

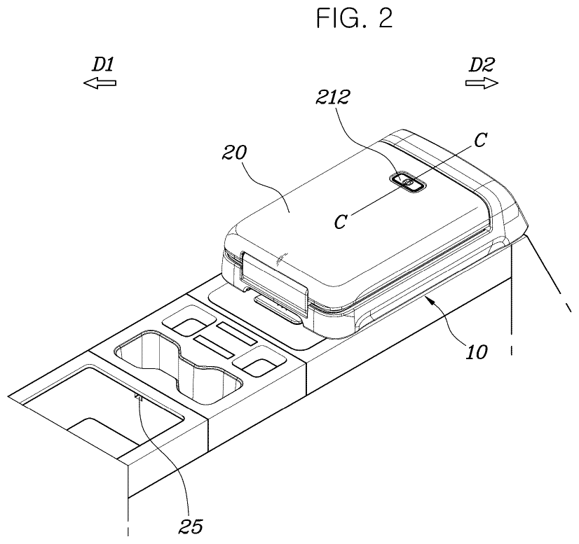

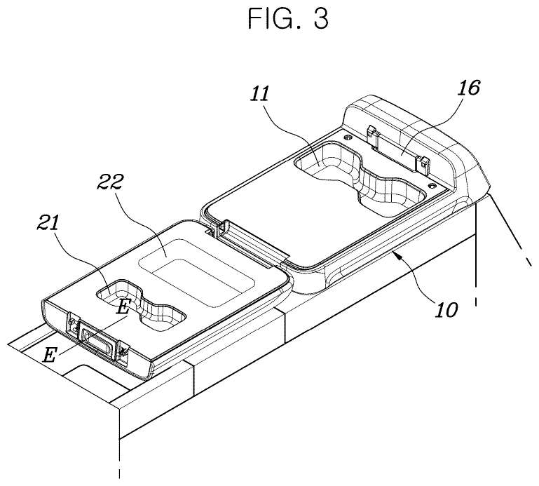

FIG. 1 is a view illustrating an example of a floor console of a vehicle. FIGS. 2 and 3 are views illustrating example states of the floor console in FIG. 1. In some examples, referring to FIGS. 2 and 3, the floor console can include a gear shift lever for controlling the vehicle, a knob for operating an in-vehicle infotainment system, or the like. In particular, FIG. 2 illustrates a state in which a multifunctional panel is rotated in a first direction, and FIG. 3 illustrates a state in which the multifunctional panel is rotated in a second direction. For instance, the first direction can refer to a clockwise rotation direction or a right direction in FIG. 2, and the second direction can refer to a counter-clockwise rotation direction or a left direction in FIG. 3.

In some implementations, a storage box of the vehicle can be formed in a base 10 of the floor console of the vehicle. A single storage box or a plurality of storage boxes can be formed. In addition, the base 10 can also constitute a portion of an armrest on which a driver or passenger's arm can be rested.

In some implementations, the floor console can include a panel configured to couple to the base 10. For example, the panel can include or be a multifunctional panel 20 is coupled to an end of the base 10. The multifunctional panel 20 is hingedly coupled to the base 10 so as to be rotatable in a first direction D1 or a second direction D2.

A soft cushion, such as foam, can be formed on one surface of the multifunctional panel 20 such that the multifunctional panel 20 can function as an armrest when rotated in the first direction. When the multifunctional panel 20 is rotated in the first direction, a base storage space 11 formed in the base 10 is exposed to be available for use. That is, the base storage space 11 is formed in an inwardly recessed shape on an upper surface of the base 10, and is available for use since the base storage space 11 is opened when the multifunctional panel 20 is rotated in the first direction.

In addition, when rotated in the second direction, the multifunctional panel 20 can perform various functions. For example, a panel storage space 21, which is inwardly recessed, can be formed on the other surface of the multifunctional panel 20 such that the multifunctional panel 20 can function as a table. The panel storage space 21 is provided on the other surface of the multifunctional panel 20 so as to store an item when the multifunctional panel 20 is rotated in the second direction. In addition, a third storage space 22, which is inwardly recessed, can be provided so as to hold a smartphone or a smart pad.

In addition, the multifunctional panel 20 can remain secured, whether the multifunctional panel 20 is rotated in the first direction or the multifunctional panel 20 is rotated in the second direction. This is because if the multifunctional panel 20 does not remain secured, the multifunctional panel 20 can rotate in the first direction or the second direction depending on the vehicle behavior when the vehicle is driving, and an occupant of the vehicle can be injured by any movement of the multifunctional panel 20 in the event of a vehicle collision.

To prevent this, when rotated in the first direction or the second direction, the multifunctional panel 20 can be secured to the base 10. A securing module 200 is provided on one side of the multifunctional panel 20, and a portion of the securing module 200 is inserted into an end of the base 10 to secure the multifunctional panel 20 to the base 10.

With the securing module 200 provided on the multifunctional panel 20, the multifunctional panel 20 can be secured to the base 10 when the multifunctional panel 20 is rotated in the first direction or the second direction, and the multifunctional panel 20 can remain rotated even when the vehicle is driving, thereby enabling stable use of the multifunctional panel 20.

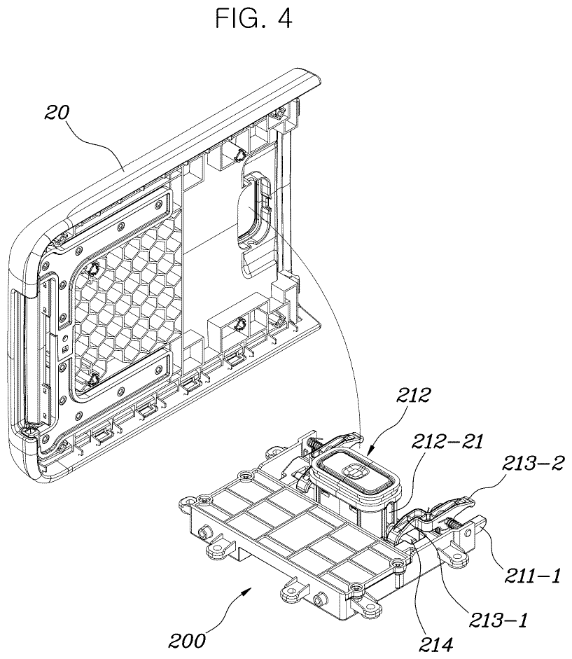

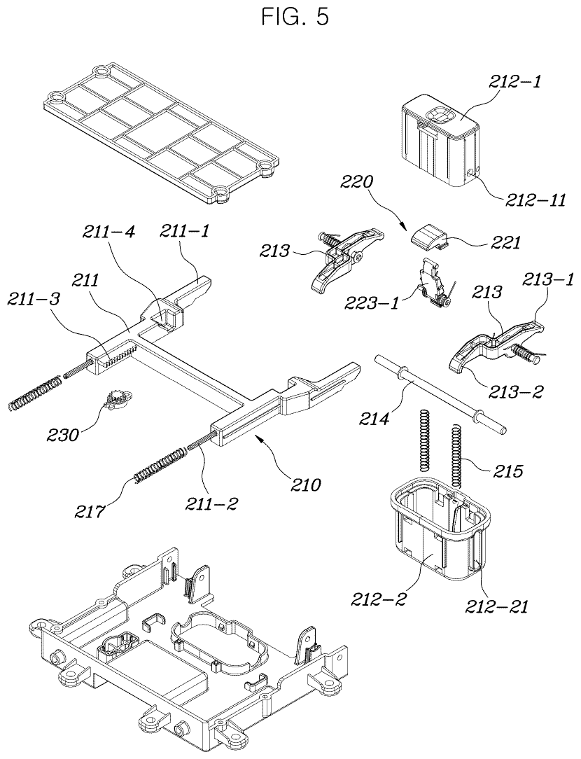

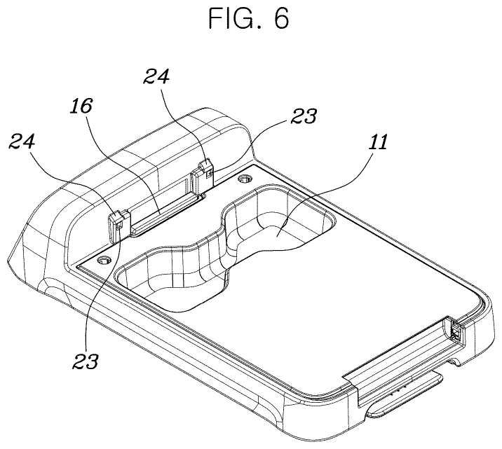

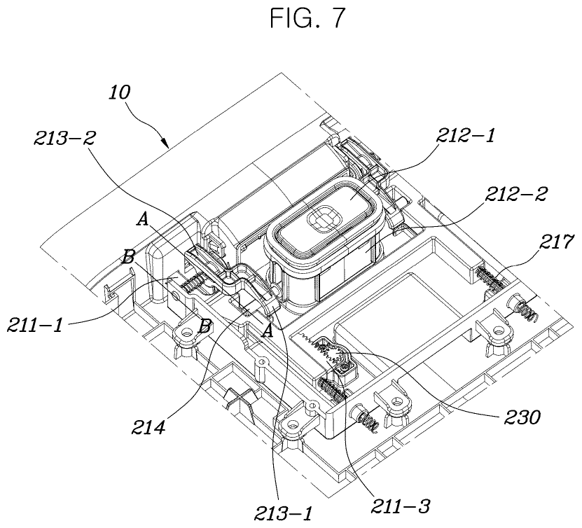

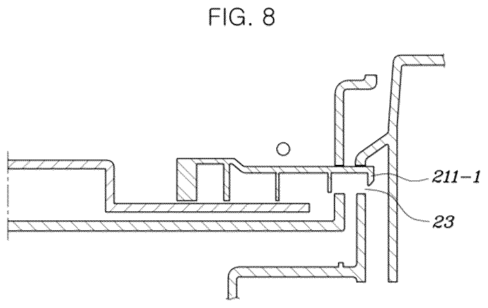

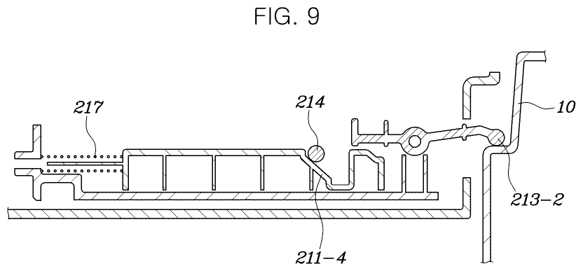

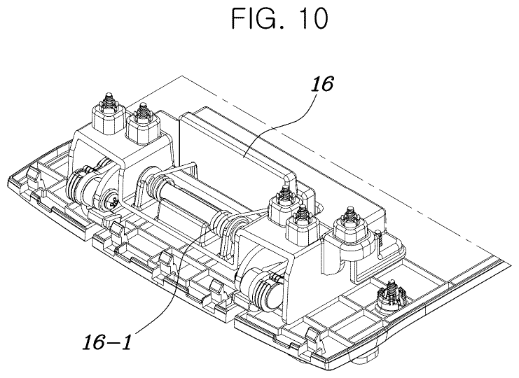

The following is a more detailed description of how the securing module 200 of the multifunctional panel 20 operates. FIG. 4 is an exploded view illustrating a multifunctional panel and a securing module provided therein. FIG. 5 is an exploded view illustrating a portion of first and second securing parts of the securing module. FIG. 6 is a view illustrating a portion of a base to describe securing of the multifunctional panel rotated in a first direction. FIG. 7 is a view illustrating a state in which a first securing hook of the securing module is inserted into a first securing groove to describe securing of the multifunctional panel rotated in the first direction. FIG. 8 is a cross-sectional view taken along line B-B in FIG. 7. FIG. 9 is a cross-sectional view taken along line A-A in FIG. 7. FIG. 10 is a view illustrating a structure of a striker.

To describe the present disclosure based on a state in which when rotated in the first direction, the multifunctional panel 20 is secured to the base 10, securing of the multifunctional panel 20 in the first direction state will be first briefly discussed.

Referring to FIG. 4, the securing module 200 is bolted so as to be secured to an inner side of the multifunctional panel 20. Then, referring to FIG. 5, a first securing hook 211 of the securing module 200 is pressurized by a pressurizing member 217 (spring), which will be described later, and inserted into a first securing groove 23 illustrated in FIG. 6. Referring to FIG. 6, there is a guide surface 24, which is inclined, above the first securing groove 23 of the base 10 corresponding to the first securing hook 211. Accordingly, when the first securing hook 211 moves down along the guide surface 24, the pressurizing member 217 is contracted; and at the moment when the first securing hook 211 corresponds to the first securing groove 23, the pressurizing member 217 that has been contracted expands again to insert the first securing hook 211 into the first securing groove 23. Referring to FIG. 7, a state in which the first securing hook 211 is inserted into the first securing groove 23 can be observed.

Referring to FIG. 5, the securing module 200 can include: a first securing part 210 for securing the multifunctional panel 20, rotated in the first direction, to the base 10; and a second securing part 220 for securing the multifunctional panel 20, rotated in the second direction, to the base 10. The securing module 200 slides the first securing part 210 or the second securing part 220 to insert a portion of the first securing part 210 or the second securing part 220 into the first securing groove 23 or a second securing groove 25 of the base 10, thereby securing the multifunctional panel 20 rotated in the first direction or in the second direction. In addition, an external force acting on the securing module 200 can cause the first securing part 210 or the second securing part 220 to slide, thereby releasing the securing of the multifunctional panel 20 to the base 10. In some examples, the securing module 200 can include at least one coupling portion including the first securing part 210 and the second securing part 220.

In some implementations, the first securing part 210 can include a first button 212, the first securing hook 211, and a first connecting link 213; and the first securing hook 211 can be inserted into or disengaged from the first securing groove 23 of the base 10, thereby securing the multifunctional panel 20 to the base 10 or releasing the securing of the multifunctional panel 20 to the base 10.

The first button 212 is accommodated in the multifunctional panel 20 such that an end of the first button 212 is exposed. That is, referring to FIGS. 2 and 4, with the multifunctional panel 20 rotated in the first direction, one surface of the first button 212 can be exposed to the outside of the multifunctional panel 20, and an external force can be applied to the first button 212 through the exposed one surface of the first button 212.

As described above, the first securing hook 211 is inserted into or disengaged from the first securing groove 23 of the base 10 to directly secure the multifunctional panel 20 to the base 10 or release the securing of the multifunctional panel 20 to the base 10.

In addition, the first connecting link 213 is provided between the first button 212 and the first securing hook 211, wherein the first connecting link 213 is configured to slide the first securing hook 211 when an external force is applied to the first button 212. That is, the first connecting link 213 slides the first securing hook 211 through the external force applied to the first button 212, thereby causing an end of the first securing hook 211 to be disengaged from the first securing groove 23.

A first end 211-1 of the first securing hook 211 is inserted into the first securing groove 23 to secure the multifunctional panel 20 to the base 10, and the pressurizing member 217 is provided at a second end 211-2 of the first securing hook 211 to pressurize the first securing hook 211 toward the outside of the securing module 200. Accordingly, when the first end 211-1 of the first securing hook 211 is inserted into the first securing groove 23, the first securing hook 211 can remain inserted by the pressurizing member 217.

The first button 212 is provided with a first securing hook sliding shaft 214 for connecting the first connecting link 213 and the first button 212. The connection between the first securing hook sliding shaft 214 and the first button 212 will be discussed below. Referring to FIG. 5, the first button 212 includes a first lower housing 212-2 and a first upper housing 212-1 that form an exterior shape of the first button 212. A coupling groove 212-11, to which the first securing hook sliding shaft 214 can be coupled, is formed in the first upper housing 212-1. A sliding groove 212-21 is formed in the first lower housing 212-2 such that the first securing hook sliding shaft 214 can move up and down together with the first upper housing 212-1.

In addition, referring to FIGS. 4 and 7, an end of the first connecting link 213 is supported on the first securing hook sliding shaft 214. With such a connected configuration, when an external force acts on a button housing, the first securing hook sliding shaft 214 is pressurized by the external force and moves down along the sliding groove 212-21. In this case, referring to FIG. 9, a slope 211-4, on which both ends of the first securing hook sliding shaft 214 are supported, is formed on a side of the first securing hook 211; and the first securing hook sliding shaft 214 moves down along the slope 211-4 and slides the first securing hook 211 backward to disengage the first securing hook 211 from the first securing groove 23.

Specifically, a first end 213-1 of the first connecting link 213 is supported on the first securing hook sliding shaft 214, and a second end 213-2 of the first connecting link 213 is supported on an end of the base 10. In addition, a portion between the first end 213-1 and the second end 213-2 can be hingedly coupled to an inner side of the securing module 200. The first end 213-1 and the second end 213-2 of the first connecting link 213 can perform a seesaw motion around an inner point of the securing module 200 to which the first connecting link 213 is hingedly coupled. That is, when the first securing hook sliding shaft 214 is pressurized and slides downward, the first end 213-1 of the first connecting link 213 also moves down accordingly, and the second end 213-2 of the first connecting link 213 temporarily moves up.

When the securing of the multifunctional panel 20 and the base 10 is released, an external force greater than an elastic force of the pressurizing member 217, which is pressurizing the first securing hook 211, can act on the first button 212, such that the first securing hook 211 can slide backward and be disengaged from the first securing groove 23. Accordingly, the securing of the multifunctional panel 20 to the base 10 can be released such that the multifunctional panel 20 can become rotatable.

In some implementations, upon the release of the securing of the multifunctional panel 20 in the first direction, rotation of the multifunctional panel 20 in the second direction and a pop-up movement of the first button 212 can occur almost simultaneously. The movements will be discussed below.

In order to prevent the first end 211-1 of the first securing hook 211 from being inserted back into the first securing groove 23 due to the action of an elastic force of the pressurizing member 217 when the first securing hook 211 is disengaged from the first securing groove 23, a striker 16 having a kick member 16-1 provided therein is formed on one side of the base 10 so as to apply a rotational force to the multifunctional panel 20 in the second direction. For example, the striker 16 can include a projection that protrudes upward from an inner surface of the base 10 configured to face an inner surface of the multifunctional panel 20.

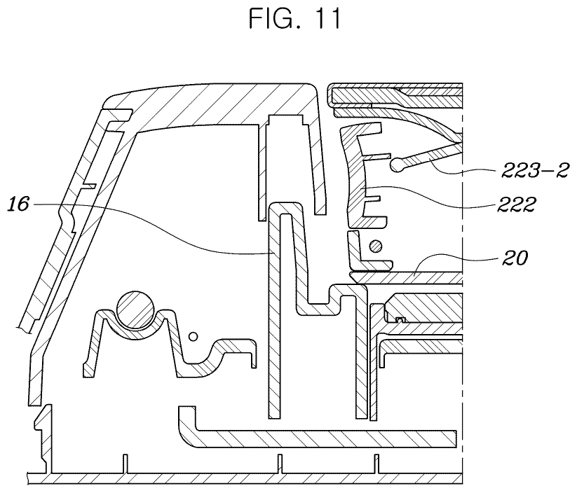

FIG. 11 is a cross-sectional view taken along line C-C in FIG. 2. Refer to FIGS. 6, 10, and 11. Referring to FIG. 11, when rotated in the first direction, the multifunctional panel 20 is secured to the base 10 by the first securing hook 211. In this case, a portion of the multifunctional panel 20 is pressurizing the striker 16.

The kick member 16-1, which exerts a force to cause the striker 16 to spring upward, is provided inside the striker 16. For example, the kick member 16-1 can include an elastic element such as a spring. The kick member 16-1 is coupled to the striker 16, and the kick member 16-1 generates a force that lifts the striker 16 upward.

In some cases, since the first securing hook 211 is inserted into the first securing groove 23 such that the multifunctional panel 20 is secured, the pressurization of the multifunctional panel 20 exerts a pressure on the kick member 16-1 and the striker 16 in a direction toward the ground surface. In this case, when the first securing hook 211 is disengaged from the first securing groove 23 and the securing of the multifunctional panel 20 and the base 10 is released, the striker 16 is actuated by the kick member 16-1, and the striker 16 applies a force to the multifunctional panel 20 in the second direction. In this case, there is a possibility that the first securing hook 211 is inserted back into the first securing groove 23 of the base 10 by the pressurizing member 217. In some cases, if an external force applied to the first button 212 is maintained for a short period of time, the first securing hook 211 can be prevented from being inserted into the first securing groove 23.

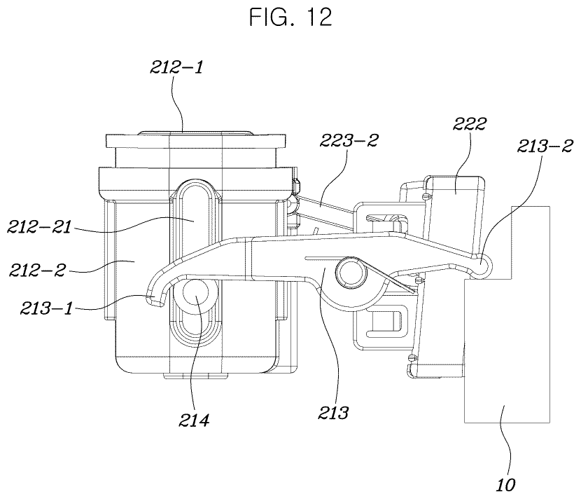

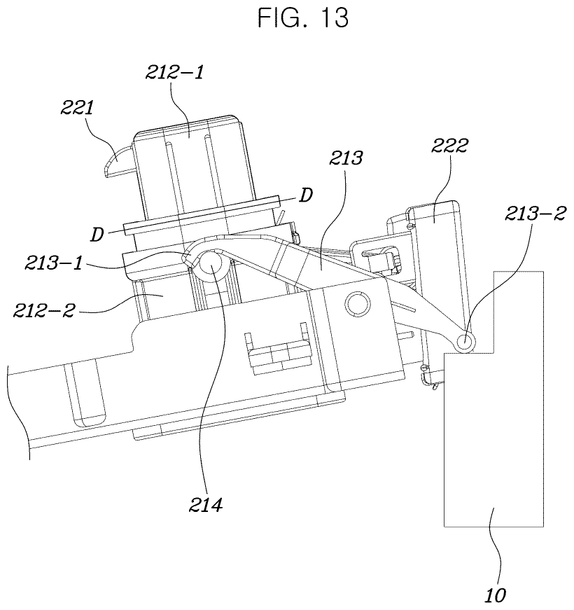

When the striker 16 moves the multifunctional panel 20, the multifunctional panel 20 becomes rotatable. Unless the multifunctional panel 20 is pressurized again in the first direction, the multifunctional panel 20 remains rotatable. Referring to FIGS. 12 and 13, it can be observed that the second end 213-2 of the first connecting link 213 supports a portion of the base 10; and when the multifunctional panel 20 is rotated a predetermined distance in the second direction by the striker 16, the second end 213-2 of the first connecting link 213 pressurizes a portion of the base 10 to restrain the multifunctional panel 20 from rotating in the first direction.

In addition, as will be described later, when the first upper housing 212-1 of the first button 212 is popped up by an elastic member 215 disposed inside the first button 212, the first securing hook sliding shaft 214 connected to the first upper housing 212-1 slides upward; and the first securing hook sliding shaft 214 is supported by the first end 213-1 of the first connecting link 213. Accordingly, the multifunctional panel 20 can remain rotatable.

The pop-up of the first button 212 of the securing module 200 occurs almost simultaneously with the release of the securing of the multifunctional panel 20 rotated in the first direction. Referring to FIG. 5, the first button 212 includes a button housing including the first lower housing 212-2 and the first upper housing 212-1 that form an exterior shape of the first button 212; and the elastic member 215 configured to pressurize the first upper housing 212-1 upward is provided between the first lower housing 212-2 and the first upper housing 212-1.

The elastic member 215 can be a spring, and a coupling protrusion 212-3, having a diameter corresponding to an inner diameter of the elastic member 215, is formed on an inner side of the first upper housing 212-1 and the first lower housing 212-2. With the multifunctional panel 20 secured to the base 10 through the first securing hook 211, the elastic member 215 remains contracted. That is, when the multifunctional panel 20 is secured to the base 10 through the first securing hook 211, the first end 213-1 of the first connecting link 213 pressurizes the first securing hook sliding shaft 214 downward and slides the first upper housing 212-1 and the first securing hook sliding shaft 214 downward. Accordingly, the elastic member 215 disposed between the first upper housing 212-1 and the first lower housing 212-2 is contracted.

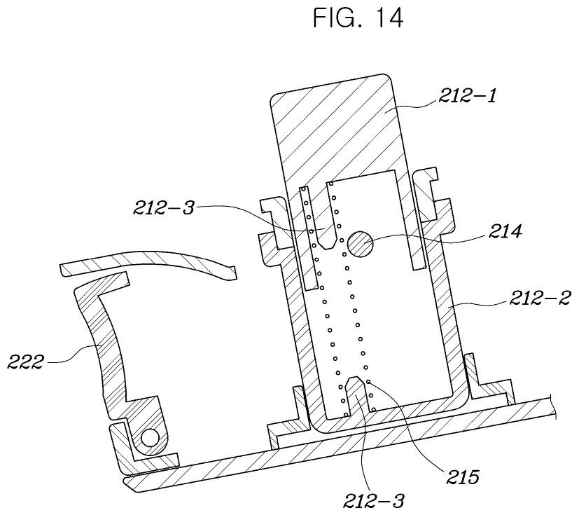

In this case, referring to FIG. 14, at the moment when the securing of the multifunctional panel 20 and the base 10 is released, the elastic member 215, which has been contracted, expands and lifts the first upper housing 212-1, and at the same time, the first securing hook sliding shaft 214 also slides upward. The first upper housing 212-1 that has been lifted protrudes to the outside of the multifunctional panel 20.

In addition, a second securing hook 221 is provided on an inner side of the first button 212 for securing the multifunctional panel 20 to the base 10 in the second direction. The second securing hook 221 constitutes a portion of the second securing part 220; and the movement for securing the multifunctional panel 20 to the base 10 in the second direction is described below.

The multifunctional panel 20, which is released from securing to the base 10, becomes rotatable in the second direction. When the rotation of the multifunctional panel 20 in the second direction is completed, the multifunctional panel 20 can be secured back to the base 10 through the second securing part 220.

The second securing part 220 of the securing module 200 serves to secure the multifunctional panel 20 to the base 10 when the multifunctional panel 20 is rotated in the second direction, or to release the securing of the multifunctional panel 20 that has been rotated in the second direction and secured to the base 10.

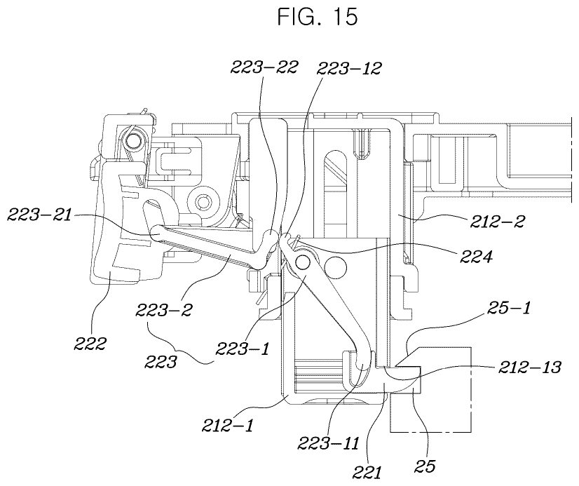

Referring to FIG. 2, a portion of the second securing part 220 is inserted into the second securing groove 25 formed at a point of the base 10, such that the multifunctional panel 20 is secured to the base 10. FIG. 15 is a cross-sectional view taken along line E-E in FIG. 3. Referring to FIG. 15, in some implementations, the second securing part 220 can include a second button 222, the second securing hook 221, and a second connecting link 223; and the second securing hook 221 can be inserted into or disengaged from the second securing groove 25 of the base 10 to secure the multifunctional panel 20 to the base 10 or release the securing of the multifunctional panel 20 to the base.

As illustrated in FIG. 3, the second securing groove 25 can be provided at a point corresponding to the second securing hook 221 when the rotation of the multifunctional panel 20 in the second direction is completed.

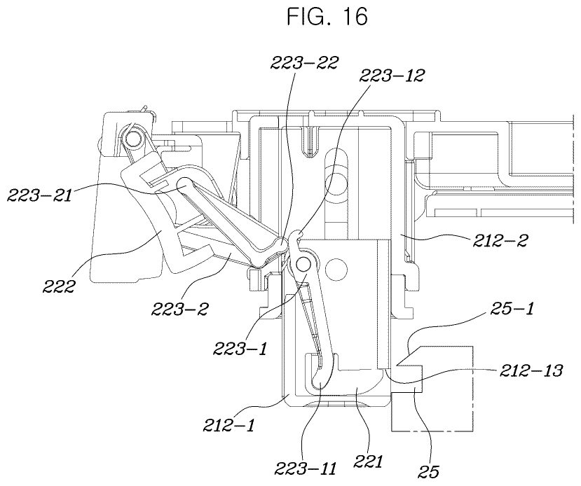

Referring to FIGS. 3 and 15, the second button 222 is accommodated in the multifunctional panel 20 such that an end of the second button 222 is exposed. In particular, the end of the second button 222 is exposed when the multifunctional panel 20 is rotated in the second direction. In addition, an external force can be applied to the second button 222 through the exposed end of the second button 222. In addition, the second button 222 is hingedly coupled to one side of the multifunctional panel 20 such that the second button 222 can be rotated inward into the multifunctional panel 20 when an external force is applied, as shown in FIG. 16.

The second securing hook 221 is inserted into or disengaged from the second securing groove 25 of the base 10 to directly secure the multifunctional panel 20 to the base 10 or release the securing of the multifunctional panel 20 to the base.

In addition, the second connecting link 223 is provided between the second button 222 and the second securing hook 221, wherein the second connecting link 223 is configured to slide the second securing hook 221 when an external force is applied to the second button 222. That is, the second connecting link 223 slides the second securing hook 221 through the external force applied to the second button 222, thereby causing an end of the second securing hook 221 to be disengaged from the second securing groove 25.

The second securing hook 221 is provided on an inner side of the first upper housing 212-1. A hook groove 212-13 is formed in the first upper housing 212-1, wherein the second securing hook 221 can slide through the hook groove 212-13 and be exposed to the outside. The second securing hook 221 can penetrate the hook groove 212-13 to secure the multifunctional panel 20 to the base 10, or to release the securing of the multifunctional panel 20 to the base 10.

When the multifunctional panel 20 is rotated in the first direction, the second securing hook 221 is accommodated inside the first upper housing 212-1. In some cases, when the securing of the multifunctional panel 20 to the base 10 is released, the second securing hook 221 slides and is exposed to the outside of the first upper housing 212-1 through the hook groove 212-13 simultaneously with the pop-up of the first upper housing 212-1.

Specifically, the second connecting link 223 can be provided on an inner side of the first upper housing 212-1 and include a second securing hook sliding link 223-1, wherein a first end 223-11 of the second securing hook sliding link 223-1 is connected to the second securing hook 221, and a second end 223-12 thereof is hingedly coupled to the inner side of the first upper housing 212-1. In addition, the second securing hook sliding link 223-1 can be hingedly coupled to the first upper housing 212-1 by a torsion spring 224. Accordingly, the torsion spring 224 can move the second securing hook sliding link 223-1 to pressurize the second securing hook 221 toward the second securing groove 25. That is, when the first upper housing 212-1 pops up, an elastic force of the torsion spring 224 coupled to the second securing hook sliding link 223-1 acts to apply a force to the second securing hook sliding link 223-1, such that the second securing hook sliding link 223-1 moves, and the second securing hook 221 connected to the first end 223-11 of the second securing hook sliding link 223-1 is exposed to the outside of the hook groove 212-13.

In addition, the second securing hook 221 comes into contact with a peripheral portion 25-1 of the second securing groove 25 just before the second securing hook 221 is inserted into the second securing groove 25 of the base 10. In this case, when the multifunctional panel 20 is pressurized in the second direction with a force greater than the elastic force of the torsion spring 224, the second securing hook 221 moves inward into the hook groove 212-13. Then, when the rotation of the multifunctional panel 20 in the second direction is completed, the second securing hook 221 can be inserted into the second securing groove 25 due to the action of the torsion spring 224. In this way, when rotated in the second direction, the multifunctional panel 20 can be secured to the base 10.

Referring to FIGS. 15 and 16, the second connecting link 223 can further include a disengaging link 223-2 in addition to the second securing hook sliding link 223-1. A first end 223-21 of the disengaging link 223-2 can be supported on the second button 222, and a second end 223-22 of the disengaging link 223-2 can be supported on the second end 223-12 of the second securing hook sliding link 223-1. Accordingly, as shown in FIG. 16, when an external force is applied to the second button 222 such that the second button 222 rotates inward into the multifunctional panel 20, the second button 222 moves the disengaging link 223-2, and the second end 223-22 of the disengaging link 223-2 applies a force to the second end 223-12 of the second securing hook sliding link 223-1 to rotate the second securing hook sliding link 223-1, thereby disengaging the second securing hook 221 from the second securing groove 25. With the external force applied to the second button 222, the second securing hook 221 can be disengaged from the second securing groove 25, and the multifunctional panel 20 becomes rotatable in the first direction.

After disengaging the second securing hook 221 from the second securing groove 25, slightly rotating the multifunctional panel 20 in the first direction and then releasing an external force applied to the second button 222 causes the second securing hook 221 to be exposed again to the outside of the hook groove 212-13 by the torsion spring 224. In some cases, the second securing hook 221 can span over the peripheral portion 25-1 of the second securing groove 25 (In some cases, if a weight of the multifunctional panel 20 is greater than the elastic force of the torsion spring 224, gravity causes the multifunctional panel 20 to rotate again in the second direction. This can usually be adjusted by changing the design of the torsion spring 224).

In addition, when the multifunctional panel 20 is rotated in the first direction, the first end 211-1 of the first securing hook 211 can come into contact with the guide surface 24 of the base 10 and then be inserted into the first securing groove 23, such that when rotated in the first direction, the multifunctional panel 20 can be secured back to the base 10.

As described above, a series of processes has been discussed in which when secured to the base 10 in the first direction, the multifunctional panel 20 is secured to the base 10 in the second direction, and then secured back to the base 10 in the first direction.

In addition, as described above, when an external force is applied to the first button 212 to release the securing of the multifunctional panel 20 to the base 10, the first securing hook 211 is disengaged from the first securing groove 23. In some cases, if an external force is applied to the first button 212 for a short period of time, the action of the kick member 16-1 provided in the striker 16 and the action of the pressurizing member 217 provided at the second end 211-2 of the first securing hook 211 can occur simultaneously. Accordingly, the first securing hook 211 can be inserted back into the first securing groove 23 or damaged by colliding with the adjacent area of the first securing groove 23.

Accordingly, in the floor console of a vehicle according to the present disclosure, a gear rack 211-3 that protrudes from one side of the first securing hook 211 can be formed; and a gear damper 230 can be provided at an end of the securing module 200, wherein the gear damper 230 engages with the gear rack 211-3 of the first securing hook 211 to restrain the first securing hook 211 from sliding.

Referring to FIGS. 5 and 7, the gear damper 230 is rotatably coupled around an end of the securing module 200. For example, the gear damper 230 can be configured to resist the pressurization of the first securing hook 211 by the elastic force of the pressurizing member 217.

In some examples, when the securing of the multifunctional panel 20 to the base 10 is released through the gear rack 211-3 and the gear damper 230, a rapid protruding of the first securing hook 211 can be prevented, and a time can be secured for the striker 16 to operate before the first securing hook 211 is inserted into the first securing groove 23, thereby preventing malfunction.

Although various implementations of the present disclosure have been illustrated and described, it will be apparent to those skilled in the art to which the present disclosure pertains that various modifications and changes to the present disclosure can be made without departing from the technical spirit of the present disclosure provided in the following claims.

What is claimed is:

1. A floor console of a vehicle, the floor console comprising:
a base comprising (i) a portion of a storage box of the vehicle or (ii) a portion of an armrest of the vehicle; and
a panel hingedly coupled to the base and configured to rotate in a first direction and a second direction relative to the base, the panel comprising a securing module disposed at one side thereof,
wherein the securing module comprises at least one coupling portion that is configured to, based on the panel rotating in the first direction or the second direction relative to the base, insert into an end of the base and couple to the base.

2. The floor console of claim 1, wherein the base defines:
a first securing groove at a first end of the base, the first securing groove being configured to, based on the panel rotating in the first direction relative to the base, receive the at least one coupling portion of the panel and secure the panel; and
a second securing groove at a second end of the base, the second securing groove being configured to, based on the panel rotating in the second direction relative to the base, receive the at least one coupling portion of the panel and secure the panel.

3. The floor console of claim 2, wherein the at least one coupling portion of the securing module comprises:
a first securing part configured to insert into the first securing groove of the base, and
a second securing part configured to insert into the second securing groove of the base.

4. The floor console of claim 1, wherein the panel comprises:
a first surface configured to define a surface of the armrest of the vehicle based on the panel rotating in the first direction relative to the base and coupling to the base; and
a second surface configured to define a table of the vehicle based on the panel rotating in the second direction relative to the base and coupling to the base.

5. The floor console of claim 1, wherein the base defines a base storage space that is inwardly recessed from an upper surface of the base, and
wherein the panel is configured to, based on rotating in the first direction relative to the base, cover the base storage space.

6. The floor console of claim 1, wherein the panel defines a panel storage space that is recessed from an inner surface of the panel, and
wherein the panel is configured to, based on rotating in the second direction relative to the base, expose the inner surface of the panel and the panel storage space.

7. The floor console of claim 1, wherein the securing module is disposed at an inner side of the panel,
wherein the at least one coupling portion of the securing module comprises a first securing part and a second securing part, and
wherein the securing module is configured to release coupling of the panel and the base based on the first securing part or the second securing part moving relative to the base.

8. The floor console of claim 1, further comprising:
a striker disposed at one side of the base and configured to move the panel; and
a kick member disposed at a side of the striker and configured to provide a rotational force to the panel in the second direction,
wherein the kick member is configured to:
be pressurized based on the panel rotating in the first direction relative to the base and coupling to the base, and
apply an elastic force to the striker to thereby provide the rotational force to the panel in the second direction based on the panel being released from the base.

9. The floor console of claim 7, wherein the first securing part comprises:
a first button accommodated in the panel and configured to receive an external force, the first button having an end that is exposed to an outside of the panel;
a first securing hook connected to the first button and configured to move relative to the first button based on the external force being applied to the first button; and
a first connecting link that connects the first button to the first securing hook and configured to move the first securing hook based on the external force being applied to the first button.

10. The floor console of claim 9, wherein the first button comprises:
a button housing comprising a first lower housing and a first upper housing that define an exterior shape of the first button; and
a first securing hook sliding shaft connected to a portion between the button housing and the first securing hook and configured to move up and down in the button housing, the first securing hook sliding shaft being configured to move the first securing hook based on the external force being applied to the button housing,
wherein the first securing hook sliding shaft is configured to support an end of the first connecting link and to move the first securing hook while being pressured by the external force applied to the button housing.

11. The floor console of claim 10, wherein the first securing hook comprises a slope that is disposed at a side of the first securing hook and supports ends of the first securing hook sliding shaft, and
wherein the first securing hook sliding shaft is configured to move along the slope and to move the first securing hook based on the external force being applied to the button housing.

12. The floor console of claim 9, wherein the first button comprises a first securing hook sliding shaft that supports a first end of the first connecting link,
wherein an end of the base supports a second end of the first connecting link, and
wherein a portion of the first connecting link between the first end and the second end of the first connecting link is hingedly coupled to an inner side of the securing module.

13. The floor console of claim 9, wherein the first button comprises:
a button housing comprising a first lower housing and a first upper housing that define an exterior shape of the first button; and
an elastic member disposed between the first lower housing and the first upper housing and configured to pressurize the first upper housing upward, and
wherein the first upper housing is configured to protrude to an outside of the panel based on the panel rotating in the first direction relative to the base and being released from the base.

14. The floor console of claim 9, wherein the base defines a first securing groove configured to couple to the panel,
wherein the first securing hook comprises a first end configured to insert into the first securing groove of the base, and
wherein the floor console further comprises a pressurizing member disposed at a second end of the first securing hook and configured to pressurize the first securing hook toward an outside of the securing module.

15. The floor console of claim 9, wherein the first securing hook comprises a gear rack that protrudes from one side of the first securing hook,
wherein the securing module comprises a gear damper configured to engage with the gear rack of the first securing hook and to restrain the first securing hook from moving relative to the first button, and
wherein the gear damper is rotatably provided at an end of the securing module and configured to be rotated by movement of the first securing hook.

16. The floor console of claim 7, wherein the second securing part comprises:
a second button accommodated in the panel and configured to receive an external force, the second button having an end exposed to an outside of the panel;
a second securing hook connected to the second button and configured to move relative to the second button based on the external force being applied to the second button; and
a second connecting link that connects the second button to the second securing hook and configured to move the second securing hook relative to the second button based on the external force being applied to the second button.

17. The floor console of claim 7, further comprising:
a first button comprising a button housing, the button housing comprising a first lower housing and a first upper housing that define an exterior shape of the first button, wherein the first upper housing defines a hook groove at one side thereof;
an elastic member disposed between the first lower housing and the first upper housing and configured to pressurize the first upper housing upward, wherein the first upper housing is configured to, based on the panel rotating in the first direction relative to the base and being released from the base, protrude to an outside of the panel;
a second button accommodated in the panel and configured to receive an external force, the second button having an end exposed to the outside of the panel;
a second securing hook connected to the second button and configured to move relative to the second button based on the external force being applied to the second button; and
a second connecting link that connects the second button to the second securing hook and configured to move the second securing hook relative to the second button based on the external force being applied to the second button, and
wherein the second securing hook is disposed at an inner side of the first upper housing and configured to, based on the first upper housing protruding to the outside of the panel, protrude to an outside of the first upper housing through the hook groove.

18. The floor console of claim 17, wherein the base defines a second securing groove configured to receive the second securing hook and couple to the panel in the second direction.

19. The floor console of claim 16, wherein the first securing part comprises a first upper housing, and
wherein the second connecting link comprises:
a second securing hook sliding link disposed at an inner side of the first upper housing, the second securing hook sliding link having (i) a first end connected to the second securing hook and (ii) a second end hingedly coupled to an inner side of the first upper housing; and
a disengaging link having (ii) a first end supported on the second button and (ii) a second end supported on the second end of the second securing hook sliding link.

20. The floor console of claim 19, wherein the base defines a second securing groove configured to receive the second securing hook and couple to the panel,
wherein the floor console further comprises a torsion spring that hingedly couples the second securing hook sliding link to the first upper housing, the torsion spring being configured to pressurize the second securing hook toward the second securing groove, and
wherein the second securing hook is configured to, based on the external force being applied to the second button, be released from the second securing groove and allow the panel to rotate in the second direction.
